(19) United States
(12) Patent Application Publication
(10) Pub. No.: US 2021/0357491 A1
(43) Pub. Date: Nov. 18, 2021

(54) TERMINAL ACCESS GRANT DETERMINATIONS BASED ON AUTHENTICATION FACTORS

(71) Applicant: Microsoft Technology Licensing, LLC, Redmond, WA (US)

(72) Inventors: Rachel Anne Brown TELLER, Seattle, WA (US); Sarat Chandra SUBRAMANIAM, Bellevue, WA (US); Steven James BALL, Redmond, WA (US)

(73) Assignee: Microsoft Technology Licensing, LLC, Redmond, WA (US)

(21) Appl. No.: 15/930,183

(22) Filed: May 12, 2020

(51) Int. Cl. G06F 21/34; G06F 21/36

(52) U.S. Cl. CPC G06F 21/34; G06F 2221/2113; G06F 2221/2111; G06F 21/36

(57) ABSTRACT

According to examples, an apparatus may include a memory on which is stored machine-readable instructions that may cause a processor to receive a user credential from a terminal, in which the user credential is stored in a machine-readable code on a user device and the terminal obtained the machine-readable code from the user device. The processor may also identify at least one authentication factor associated with the user based on the user credential, in which the authentication factor(s) includes a physical location associated with the user and/or a time-based factor. The processor may further determine whether the authentication factor(s) indicates that the user is to be granted access to the terminal and based on a determination that the authentication factor(s) indicates that the user is to be granted access to the terminal, may grant the user access to the terminal.

### BACKGROUND

A terminal, such as a computing device, a cash register, a handheld scanning device, or the like, may execute an application that may require that a user be authenticated prior to the user being granted access to the terminal. Particularly, for instance, the application may receive credentials from the user that may be used to authenticate the identity of the user. The credentials may include, for instance, a user identification, a user password, and the like. In addition, the user may provide the credentials through an interface of the terminal such as a keyboard, a mouse, and/or other type of input mechanism.

### BRIEF DESCRIPTION OF DRAWINGS

Features of the present disclosure are illustrated by way of example and not limited in the following figure(s), in which like numerals indicate like elements, in which:

FIG. 1 shows a block diagram of an authentication system in accordance with an embodiment of the present disclosure;

FIG. 2 depicts a block diagram of the apparatus depicted in FIG. 1, in accordance with an embodiment of the present disclosure;

FIG. 3 depicts a flow diagram of a method for determining whether to grant a user access to a terminal, which may be a shared terminal, in accordance with an embodiment of the present disclosure; and

FIG. 4 depicts a block diagram of a computer-readable medium that may have stored thereon computer-readable instructions for determining whether to grant a user access to a terminal, which may be a shared terminal, in accordance with an embodiment of the present disclosure.

### DETAILED DESCRIPTION

For simplicity and illustrative purposes, the principles of the present disclosure are described by referring mainly to embodiments and examples thereof. In the following description, numerous specific details are set forth in order to provide an understanding of the embodiments and examples. It will be apparent, however, to one of ordinary skill in the art, that the embodiments and examples may be practiced without limitation to these specific details. In some instances, well known methods and/or structures have not been described in detail so as not to unnecessarily obscure the description of the embodiments and examples. Furthermore, the embodiments and examples may be used together in various combinations.

Throughout the present disclosure, the terms “a” and “an” are intended to denote at least one of a particular element. As used herein, the term “includes” means includes but not limited to, the term “including” means including but not limited to. The term “based on” means based at least in part on.

As discussed above, a user may be required to enter credentials in order to access a terminal, e.g., for security purposes. That is, the credentials may be used to verify the identity of the user to thus prevent or limit unauthorized access to the terminal. In many workplace, factory, academic, laboratory, etc., environments, users may wear protective clothing and/or protective gear such as gloves, face shields, face masks, hazardous material suits, and/or the like. For instance, the users may wear the protective gear to protect the users as the users handle working implements, handle items, handle chemicals, handle biological samples, build and/or assemble components, and/or the like. As a result, it may be difficult for the user to enter the user's credentials via an input mechanism of the terminal. That is, for instance, users may not easily press keys on a keyboard, accurately manipulate a mouse, use the users' face in a facial recognition operation, and/or the like.

As a result, the users may not be able to enter the users' credentials, e.g., email address, user identifier, password, personal identification number, and/or the like, without first removing the protective gear. This may result in the users being exposed to harmful contaminants, dangerous conditions, etc., in order to enter the users' credentials to be authenticated to access and use the terminal. In addition or in other instances, the users may be assigned credentials on a temporary basis and/or credentials that may change over time and thus, the users may find it difficult to memorize the credentials. An issue with current authentication processes may be that they may place users in dangerous situations. As a result, some organizations may remove or reduce security requirements on the terminals to make it easier for users to use the terminals, which may subject the organizations to security vulnerabilities. A technical issue with current authentication processes may thus be that the organizations may be vulnerable to attacks and may not be able to accurately track the identities of the users of the terminals.

Disclosed herein are systems, apparatuses, methods, and computer-readable media in which a processor may determine whether a user is to be granted access to a terminal in a simple and efficient manner. Particularly, the processor disclosed herein may authenticate the user using an authentication factor that may be based on a physical location associated with the user and/or a time-based factor. In other words, instead of relying on user-inputted credential information, e.g., via a keyboard, the processor may determine whether at least one authentication factor associated with the user indicates that the user is to be granted access to the terminal.

As discussed herein, the user may be provided with a user device on which a machine-readable code may be encoded or stored. The machine-readable code, which may be a quick response (QR) code, a bar code, alphanumeric characters, and/or the like, may encode a user credential, which may be a user identification number, an email address, a symbol, a string or object representing a unique identifier, and/or the like. In order to access the terminal, the user may scan or otherwise cause the terminal to obtain the machine-readable code, which may communicate the user credential to the processor. The processor may be a processor of a server that may perform an authentication service for the terminal. In some examples, the user may also input a pin via, for instance, hand gestures or the like.

In response to receipt of the user credential, the processor may identify at least one authentication factor associated with the user, in which the at least one authentication factor may include a physical location associated with the user and/or a time-based factor. Various examples of the physical location associated with the user and the time-based factor are described in detail elsewhere herein. In addition, the processor may determine whether the at least one authentication factor indicates that the user is to be granted access to the terminal and based on a determination that the at least one authentication factor indicates that the user is to be granted access to the terminal, may grant the user access to the terminal.

Through implementation of various features of the present disclosure, a processor may determine whether a user is to be granted access to a terminal based on the user being in possession of a user device having a particular machine-readable code and meeting certain physical location and/or time-based factor requirements that a user having the particular machine-readable code is to have. As a result, the processor may authenticate the identity of the user in a simple and efficient manner without requiring that the user input additional user credentials through the terminal. As a result, a technological improvement achievable through implementation of the features of the present disclosure may be an increase in security of access to the terminal. In addition, the features of the present disclosure may improve the safety of the user as the user may not be required to remove protective equipment to access the terminal.

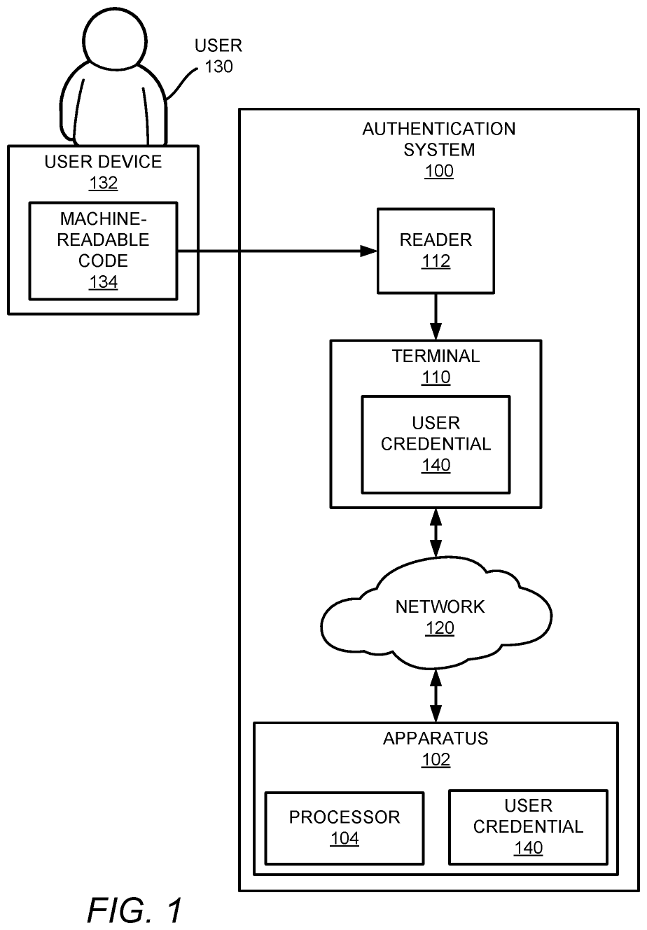

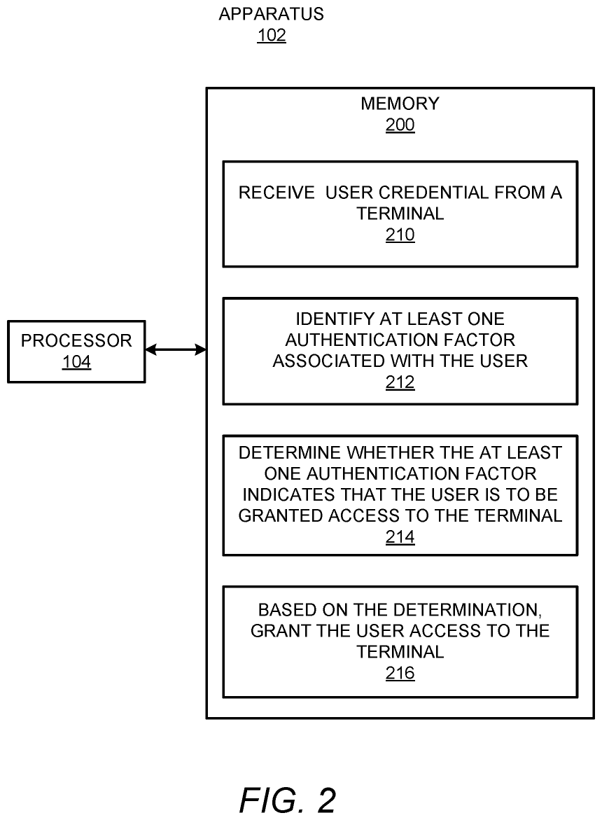

Reference is first made to FIGS. 1 and 2. FIG. 1 shows a block diagram of an authentication system 100 in accordance with an embodiment of the present disclosure. FIG. 2 depicts a block diagram of the apparatus 102 depicted in FIG. 1, in accordance with an embodiment of the present disclosure. It should be understood that the authentication system 100 and the apparatus 102 of the authentication system 100 may include additional features and that some of the features described herein may be removed and/or modified without departing from the scopes of the authentication system 100 and/or the apparatus 102.

As shown in FIG. 1, the authentication system 100 may include the apparatus 102, a terminal 110, a reader 112, and a network 120. According to examples, the apparatus 102 may be a server or other type of computing device that may provide authentication services to the terminal 110, as well as to other terminals (not shown). In addition, the terminal 110 may be a computing device, such as a personal computer, a laptop computer, a tablet computer, a smartphone, a handheld scanning device, or the like. The network 120 may be any suitable type of network through which the terminal 110 and the apparatus 102 may communicate with each other, such as the Internet, a wide area network, a local area network, or the like.

In particular examples, the terminal 110 may be shared by multiple users as may occur, for instance, in a work environment, such as a warehouse, a factory, and/or the like. For instance, the terminal 110 may be an inventory tracking terminal that multiple users may share at different times, e.g., during different shifts. As another example, the terminal 110 may be a cash register that different users may use at different times. As a further example, the terminal 110 may be a computing terminal located at a particular section of a warehouse that multiple users may access. As a yet further example, the terminal 110 may be a terminal in a hospital or other medical facility, such as a device that may be used for taking patient readings, storing health records, or the like, that different users may access. As the terminal 110 may be shared by multiple users, the terminal 110 may not store the credentials, such as the user identifiers, passwords, etc., of the users, e.g., for security purposes, for user tracking purposes, etc. In any of these examples, users may be required to provide credentials that may be authenticated prior to the users accessing the terminal 110, e.g., prior to accessing and using an application on the terminal 110.

Also shown in FIG. 1 is a user 130 and a user device 132. The user 130 may be a full-time employee of an organization, a laboratory technician, a temporary employee of an organization, a guest of an organization, a contractor of a business, and/or the like. As such, for instance, the user 130 may not own or have exclusive use of the terminal 110. Instead, as discussed herein, the user 130 may share usage of the terminal 110 with other users. In some instances, the user 130 may wear protective clothing and/or protective gear such as gloves, a face shield, a face mask, a hazardous material suit, and/or the like, as part of the work that the user 130 may perform for an organization. For instance, the user 130 may wear the protective gear to protect the user 130 as the user 130 handles working implements, handles items, handles chemicals, handles biological samples, builds and/or assembles components, and/or the like.

In instances in which the user 130 may be wearing protective gear when interacting with or using the terminal 110, it may be difficult for the user 130 to enter the user's 130 credentials via an input mechanism of the terminal 110. That is, for instance, the user 130 may not easily press keys on a keyboard, accurately manipulate a mouse, use the user's 130 face in a facial recognition operation, and/or the like. As a result, the user 130 may not be able to enter the user's 130 credentials, e.g., email address, user identifier, password, personal identification number, knowledge proof, and/or the like, without first removing the protective gear. This may result in the user 130 being exposed to harmful contaminants, dangerous conditions, etc., in order to enter the user's 130 credentials to be authenticated to access and use the terminal 110. In other instances, the user 130 may be assigned credentials on a temporary basis and/or credentials that may change over time and thus, the user 130 may find it difficult to memorize the credentials.

According to examples, the user 130 may be provided with a user device 132 that the user 130 may use to be authenticated to access the terminal 110 along with other authentication factors as discussed herein. The user device 132 may be a user-wearable device, such as an identification badge, a bracelet, a necklace, a watch, and/or the like. In any regard, the user device 132 may have stored thereon or may have printed thereon, a machine-readable code 134. The machine-readable code 134 may store or encode a user credential 140 of the user 130, such as, for instance, a user principle name (UPN), an email address, a user identification code, and/or the like. In some examples, the machine-readable code 134 may be a quick response (QR) code, a bar code, a set of numbers and/or other characters, a set of symbols, a set of colors, and/or the like. In other examples, the user device 132 may include a data storage and the machine-readable code 134 may be data stored in the data storage. In these examples, the data storage may include a radio frequency identification (RFID) tag.

According to examples, the user 130 may place the user device 132 adjacent to the reader 112 and the reader 112 may obtain, e.g., read, scan, capture an image of, etc., the machine-readable code 134 from the user device 132. For instance, the reader 112 may include a camera that may capture an image of the machine-readable code 134, a scanner that may scan the machine-readable code 134. In another example, the reader 112 may include an RFID tag reader that may obtained the machine-readable code 134 wirelessly. In any of these examples, the reader 112 may communicate the machine-readable code 134 to the terminal 110. Although the reader 112 is depicted as being separate from the terminal 110, the reader 112 may be integrated with the terminal 110.

The terminal 110 may decode the machine-readable code 134 to identify the user credential 140. In addition, the terminal 110 may communicate the user credential 140 to the apparatus 102 via the network 120. In other examples, the terminal 110 may communicate the machine-readable code 134 to the apparatus 102 and the apparatus 102 may decode the machine-readable code 134 to identify the user credential 140. In some examples, the capture of the machine-readable code 134 may cause an application in the terminal 110 to be launched, in which the application may cause the user credential 140 and/or the machine-readable code 134 to be communicated to the apparatus 102. In examples in which the machine-readable code 134 is a QR code, the reading of the QR code may cause the application to automatically be launched on the terminal 110.

In some examples, the user 130 may input another user credential (not shown) into the terminal 110. For instance, the user 130 may input a pin number or other credential through an input mechanism. By way of particular example, the user 130 may input a gesture through a finger and/or hand movement. In these examples, an authentication application executing on the terminal 110 may send the user credential 140 and/or the machine-readable code 134 to the apparatus 102 based on the other user credential being authenticated.

As discussed herein, the apparatus 102 may provide authentication services for the terminal 110 such that the apparatus 102 may determine whether or not the user 130 is to be granted access to use the terminal 110. As shown in FIGS. 1 and 2, the apparatus 102 may include a processor 104 that may control operations of the apparatus 102. The apparatus 102 may also include a memory 200 on which data that the processor 104 may access and/or may execute may be stored. The processor 104 may be a semiconductor-based microprocessor, a central processing unit (CPU), an application specific integrated circuit (ASIC), a field-programmable gate array (FPGA), and/or other hardware device. The memory 200, which may also be termed a computer readable medium, may be, for example, a Random Access memory (RAM), an Electrically Erasable Programmable Read-Only Memory (EEPROM), a storage device, or the like. The memory 200 may be a non-transitory computer readable storage medium, where the term “non-transitory” does not encompass transitory propagating signals. In any regard, the memory 200 may have stored thereon machine-readable instructions that the processor 104 may execute.

Although the apparatus 102 is depicted as having a single processor 104, it should be understood that the apparatus 102 may include additional processors and/or cores without departing from a scope of the apparatus 102. In this regard, references to a single processor 104 as well as to a single memory 200 may be understood to additionally or alternatively pertain to multiple processors 104 and multiple memories 200. In addition, or alternatively, the processor 104 and the memory 200 may be integrated into a single component, e.g., an integrated circuit on which both the processor 104 and the memory 200 may be provided.

As shown in FIG. 2, the memory 200 may have stored thereon machine-readable instructions 210-216 that the processor 104 may execute. Although the instructions 210-216 are described herein as being stored on the memory 200 and may thus include a set of machine-readable instructions, the apparatus 102 may include hardware logic blocks that may perform functions similar to the instructions 210-216. For instance, the processor 104 may include hardware components that may execute the instructions 210-216. In other examples, the apparatus 102 may include a combination of instructions and hardware logic blocks to implement or execute functions corresponding to the instructions 210-216. In any of these examples, the processor 104 may implement the hardware logic blocks and/or execute the instructions 210-216. As discussed herein, the apparatus 102 may also include additional instructions and/or hardware logic blocks such that the processor 104 may execute operations in addition to or in place of those discussed above with respect to FIG. 2.

The processor 104 may execute the instructions 210 to receive a user credential 140 from a terminal 110. As discussed herein, the user credential 140 may be stored in a machine-readable code 134 on a user device 132 and the terminal 110 may have obtained the machine-readable code 134 from the user device 132. That is, for instance, the reader 112 may have obtained the machine-readable code 134 from the user device 132 and may have communicated the machine-readable code 134 to the terminal 110. The terminal 110 may have decoded the user credential 140 from the machine-readable code 134 and may have transmitted the user credential 140 to the apparatus 102.

The processor 104 may execute the instructions 212 to identify at least one authentication factor associated with the user 130 based on the user credential 140. The at least one authentication factor may include a physical location, e.g., a two-dimensional coordinate location or a three-dimensional coordinate location, associated with the user and/or a time-based factor. The physical location associated with the user 130 may include any of a number of physical location features. For instance, the physical location associated with the user 130 may be the physical location of the user 130 when the terminal 110 (e.g., the reader 112) obtained the machine-readable code 134 from the user device 132. The physical location of the user 130 may be determined using any suitable location tracking mechanism such as through use of a global positioning system device or other tracking mechanism. By way of particular example, the user 130 may be provided with a location tracking device, the user's 130 smartphone may be used to track the user's location, etc. In addition, the processor 104 may access the user's 130 location from a tracking system (not shown) that may track the user's 130 location.

As another example, the physical location associated with the user 130 may correspond to a movement of the user 130 prior to when the terminal 110 (e.g., the reader 112) obtained the machine-readable code 134 from the user device 132. For instance, the processor 104 may determine through which sections of a building the user 130 traversed during a particular time interval prior to when the terminal 110 obtained the machine-readable code 134 from the user device 132. By way of particular example, the building may be equipped with sensors and/or other devices that may track when users open doors and/or move between sections of the building. The devices may include vision-based tracking systems, device-based tracking systems, etc. For instance, the building may include tracking systems on doors that may require that users use identification badges or the like to unlock the doors. In any regard, the processor 104 may access information pertaining to the tracked movement of the user 130 prior to, e.g., within a few hours, when the terminal 110 obtained the machine-readable code 134.

According to examples, the processor 104 may determine an authentication policy to be applied to authenticate the user 130, in which the determined authentication policy may identify the at least one authentication factor associated with the user. For instance, the processor 104 may access or implement a policy engine to determine the authentication policy that is to be applied. In some examples, the correlations between users and authentication factors to be employed may be listed in a two-dimensional matrix, which may provide a visual access graph that may be used for administrative control of access per user, e.g., based on their role. The policy engine may identify the authentication policy to be applied to authenticate the user 130 based on any of a number of factors associated with the user 130 and/or the terminal 110. By way of example, the policy engine may identify a first authentication policy for a first type of user, a second authentication policy for a second type of user, and so forth. The types of users may include, for instance, full time employees, contractors, part-time employees, visitors, and/or the like. In some examples in which some users may not consent to their locations and/or movements being tracked, the policy engine may identify an authentication policy in which an additional authentication factor may be satisfied prior to those users being authenticated.

In addition or alternatively, the policy engine may identify a first authentication policy for a first type of terminal, a second authentication policy for a second type of terminal, and so forth. The types of terminals may include, for instance, an inventory tracking terminal, a cash register, a computing device, etc. Each of the types of terminals may be associated with a security level. For instance, a cash register and a computing device may have a higher security level than an inventory tracking terminal. In some examples, the processor 104 may determine a security level associated with the terminal 110 and may determine the authentication policy to be applied to authenticate the user based on the security level associated with the terminal 110. By way of example, the authentication policy may indicate that a larger number of authentication factors and/or an authentication factor having a higher scrutiny level may be applied for terminals 110 associated with higher security levels.

The processor 104 may execute the instructions 214 to determine whether the at least one authentication factor indicates that the user 130 is to be granted access to the terminal 110. That is, the processor 104 may determine whether the user 130 is to be granted access to use and execute an application on the terminal 110, to use the terminal 110 to perform duties, and/or the like, based on whether the at least one authenticator factor complies with certain authentication information. In any regard, the processor 104 may determine whether the at least one authentication factor, e.g., a physical location of the user and/or a time-based factor, indicates that the user 130 is authorized to access the terminal 110.

The processor 104 may execute the instructions 216 to, based on a determination that the at least one authentication factor indicates that the user 130 is to be granted access to the terminal 110, grant the user 130 access to the terminal 110. The processor 104 may grant the user access to the terminal 110 in any suitable manner, e.g., by providing an appropriate key to the terminal 110 that may be used to provide the user access, or the like. However, based on a determination that the at least one authentication factor indicates that the user 130 is not to be granted access to the terminal 110, the processor 104 may deny the user 130 access to the terminal 110. For instance, the processor 104 may not provide a key to the terminal 110 that the user 130 may use to access the terminal 110. In addition, the terminal 110 may display an error message.

In examples, the processor 104 may determine whether the physical location of the user 130 is within an approved physical location of the user 130 when the terminal 110 obtained the machine-readable code 134 from the user device 132 to determine whether the at least one authentication factor indicates that the user 130 is to be granted access to the terminal 110. The approved physical location of the user 130 may be, for instance, a physical location of the user 130 that the user 130 is approved to be located at a particular time, a particular date, or the like. For instance, an approved physical location of the user 130 may be a location within a warehouse at which the user 130 is approved to be located. Based on a determination that the user 130 is in an approved physical location of the user 130, the processor 104 may grant the user 130 access to the terminal 110. However, based on a determination that the user 130 is not in an approved physical location of the user 130, the processor 104 may deny the user 130 access to the terminal 110.

In addition or in other examples, the processor 104 may determine whether the movement of the user 130 complies with a predefined movement prior to when the terminal 110 obtained the machine-readable code 134 from the user device 132 to determine whether the at least one authentication factor indicates that the user 130 is to be granted access to the terminal 110. The predefined movement may be, for instance, an approved movement of the user 130 through a building, whether the user 130 moved through particular sections of the building, etc. As another example, the predefined movement may be a tracking of the user 130 to determine that the user 130 is determined to have moved to the location of the terminal 110 and may thus be used as an indicator of the user's 130 identity. Based on a determination that the movement of the user 130 complies with the predefined movement, the processor 104 may grant the user 130 access to the terminal 110. However, based on a determination that the movement of the user 130 does not comply with the predefined movement, the processor 104 may deny the user 130 access to the terminal 110. For instance, based on a determination that the movement of the user 130 is not feasible, e.g., the user 130 is determined to be in a first location at a first time and at a second location at a second time, but the user 130 is physically unable to be both at the first location at the first time and at the second location at the second time, the processor 104 may deny the user 130 access to the terminal 110.

In addition, or in other examples, the processor 104 may determine whether the user 130 is currently or was recently logged (e.g., within a few minutes, within a few hours, or the like) into another terminal at a different geographic location to determine whether the at least one authentication factor indicates that the user 130 is to be granted access to the terminal 110. The different geographic location may be a location that is sufficiently distant from the terminal 110 that the user 130 may not be able to access the other terminal within a certain time frame of interacting with the terminal 110. For instance, the different geographic location may be a different city, a different state, a different building, or the like, from the location of the terminal 110.

The processor 104 may determine whether the user 130 is or recently was logged into another terminal at a different geographic location and if so, may determine that the identity of the user 130 may not be verified. In other words, the processor 104 may not be able to verify which of the users at the terminals in the different geographic locations is the authentic user 130. In any regard, the processor 104 may, based on a determination that the user is currently or was recently logged into another terminal at the different geographic location, determine that the user is not to be granted access to the terminal 110. However, based on a determination that the user is not current or was not recently logged into another terminal at the different geographic location, the processor 104 may determine that the user is to be granted access to the terminal 110.

In addition, or in other examples, the time-based factor may be directed to a schedule of the user 130. That is, for instance, the processor 104 may determine whether the user 130 is scheduled to be on-duty when the terminal 110 obtained the machine-readable code 134 from the user device 132 to determine whether the at least one authentication factor indicates that the user 130 is to be granted access to the terminal 110. The processor 104 may access the user's 130 work schedule to determine whether the user 130 is scheduled to be at the location of the terminal 110 at the time that the user 130 is seeking access to the terminal 110. Based on a determination that the user 130 is scheduled to be on-duty when the terminal 110 obtained the machine-readable code 134 from the user device 132, the processor 104 may determine that the user 130 is to be granted access to the terminal 110. However, based on a determination that the user 130 is not scheduled to be on-duty when the terminal 110 obtained the machine-readable code 134 from the user device 132, the processor 104 may determine that the user 130 is not to be granted access to the terminal 110.

In some examples, the processor 104 may determine whether more than one of the authentication factors discussed herein indicates that the user 130 is to be granted access to the terminal 110. Thus, for instance, the processor 104 may determine that the user 130 is to be granted access to the terminal 110 based on a determination that some or all of the authentication factors indicate that the user 130 is to be granted access to the terminal 110. In addition, the processor 104 may determine that the user 130 is not to be granted access to the terminal 110 based on a determination that one or more of the authentication factors do not indicate that the user 130 is to be granted access to the terminal 110.

According to examples, the processor 104 may access a statistical model of the user 130, in which the statistical model may define and/or model the user's 130 behavior. The processor 104 may apply any suitable statistical modeling technique to build the statistical model of the user 130, such as, clustering, K-means clustering, or the like, to model how the user 130 normally behaves. In other examples, another processor may build the statistical model of the user 130 and the processor 104 may access the built statistical model. In any regard, the processor 104 may apply the statistical model on the at least one authentication factor to determine whether the user 130 is to be granted access to the terminal 110. That is, the processor 104 may determine whether the statistical model indicates that user 130 interaction with the terminal 110 at the time when the terminal 110 obtained the machine-readable code 134 from the user device 132 complies with a modeled normal behavior of the user 130.

Based on a determination that the user 130 behavior complies with the statistical model of the user 130, the processor 104 may determine that the at least one authentication factor indicates that the user 130 is to be granted access to the terminal 110. In addition, the processor 104 may grant access to the terminal 110. However, based on a determination that the user 130 behavior does not comply with the statistical model of the user 130, the processor 104 may determine that the at least one authentication factor does not indicate that the user 130 is to be granted access to the terminal 110. In this case, the processor 104 may deny user 130 access to the terminal 110.

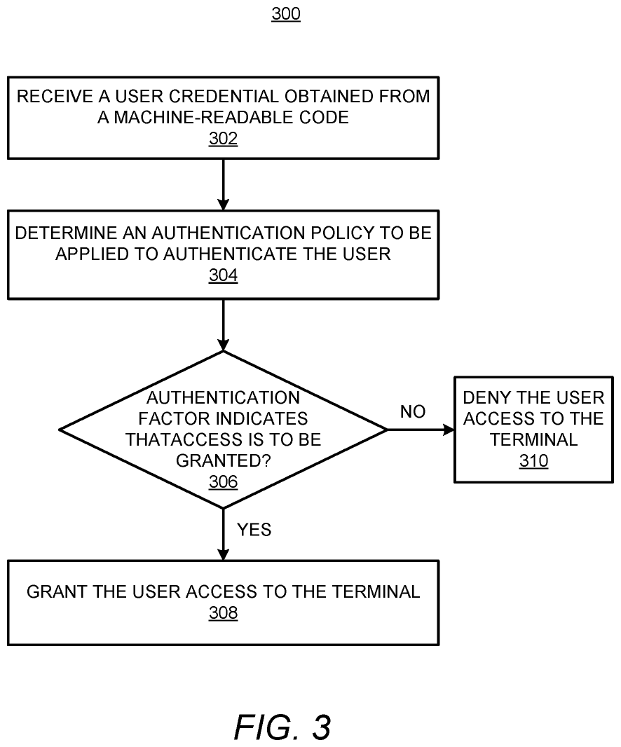

Various manners in which the processor 104 of the apparatus 102 may operate are discussed in greater detail with respect to the method 300 depicted in FIG. 3. Particularly, FIG. 3 depicts a flow diagram of a method 300 for determining whether to grant a user 130 access to a terminal 110, which may be a shared terminal, in accordance with an embodiment of the present disclosure. It should be understood that the method 300 depicted in FIG. 3 may include additional operations and that some of the operations described therein may be removed and/or modified without departing from the scope of the method 300. The description of the method 300 is made with reference to the features depicted in FIGS. 1 and 2 for purposes of illustration.

At block 302, the processor 104 may receive a user credential 140 from a terminal 110. As discussed herein, the user credential 140 may be stored in a machine-readable code 134 on a user device 132 and the terminal 110 (e.g., a reader 112 of the terminal 110) may have obtained the machine-readable code 134 from the user device 132 to obtain the user credential 140.

At block 304, the processor 104 may determine an authentication policy to be applied to authenticate the user 130. As discussed herein, the authentication policy may identify at least one authentication factor that may include a physical location associated with the user and/or a time-based factor. In addition, the processor 104 may determine a security level associated with the terminal 110 and may determine the authentication policy to be applied to authenticate the user based on the determined security level associated with the terminal 110.

At block 306, the processor 104 may determine whether the at least one authentication factor indicates that the user 130 is to be granted access to the terminal 110. The processor 104 may make this determination in an any of the manners discussed herein. For instance, the processor 104 may make this determined based on whether the physical location of the user 130 is within an approved physical location of the user 130, whether a movement of the user 130 proves an identity of the user 130, whether the user 130 is currently or was recently logged into another terminal, whether the user 130 is scheduled to be on-duty, and/or the like. The processor 104 may also or alternatively, access a statistical model of the user 130 and may determine whether the at least one authentication factor indicates that the user 130 is to be granted access to the terminal 110 based on an application of the at least one authentication factor against the statistical model of the user 130.

Based on a determination that the at least one authentication factor indicates that the user 130 is to be granted access to the terminal 110, at block 308, the processor 104 may grant the user 130 access to the terminal 110. That is, for instance, the processor 104 may provide the user 130 with the ability to use the terminal 110, to access an application executing on the terminal 110, and/or the like.

However, based on a determination that the at least one authentication factor indicates that the user 130 is not to be granted access to the terminal 110, at block 310, the processor 104 may deny the user 130 access to the terminal 110. Following block 310, the processor 104 may enable the user 130 to attempt to obtain access to the terminal 110 a predetermined number of times (e.g., a user-defined number of times) prior to, for instance, the user 130 being locked out of the terminal 110. In addition, or in other examples, the processor 104 may send a notification to an administrator to inform the administrator of the access denial such that, for instance, the administrator may manually provide the user 130 access to the terminal 110 based on another authentication routine being implemented. As other examples, the processor 104 may implement a credential recovery routine following block 310.

Some or all of the operations set forth in the method 300 may be included as utilities, programs, or subprograms, in any desired computer accessible medium. In addition, the method 300 may be embodied by computer programs, which may exist in a variety of forms both active and inactive. For example, they may exist as machine-readable instructions, including source code, object code, executable code or other formats. Any of the above may be embodied on a non-transitory computer readable storage medium.

Examples of non-transitory computer readable storage media include computer system RAM, ROM, EPROM, EEPROM, and magnetic or optical disks or tapes. It is therefore to be understood that any electronic device capable of executing the above-described functions may perform those functions enumerated above.

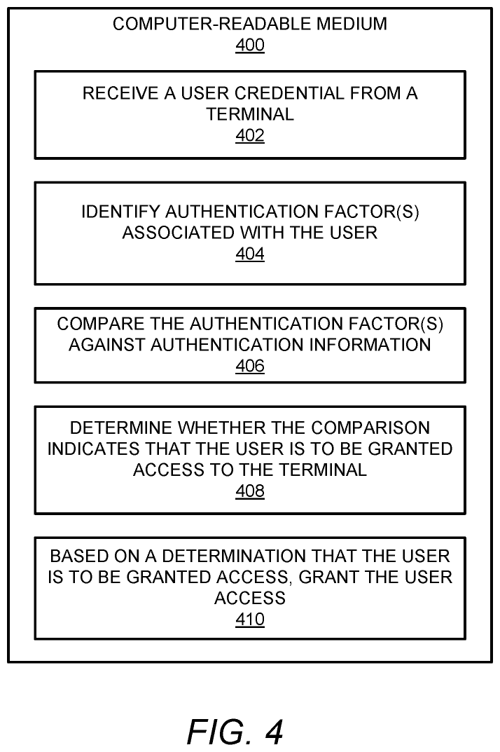

Turning now to FIG. 4, there is shown a block diagram of a computer-readable medium 400 that may have stored thereon computer-readable instructions for determining whether to grant a user 130 access to a terminal 110, which may be a shared terminal, in accordance with an embodiment of the present disclosure. It should be understood that the computer-readable medium 400 depicted in FIG. 4 may include additional instructions and that some of the instructions described herein may be removed and/or modified without departing from the scope of the computer-readable medium 400 disclosed herein. The computer-readable medium 400 may be a non-transitory computer-readable medium, in which the term “non-transitory” does not encompass transitory propagating signals.

The computer-readable medium 400 may have stored thereon computer-readable instructions 402-410 that a processor, such as the processor 104 depicted in FIGS. 1 and 2, may execute. The computer-readable medium 400 may be an electronic, magnetic, optical, or other physical storage device that contains or stores executable instructions. The computer-readable medium 400 may be, for example, Random Access memory (RAM), an Electrically Erasable Programmable Read-Only Memory (EEPROM), a storage device, an optical disc, and the like.

The processor may fetch, decode, and execute the instructions 402 to receive a user credential 140 from a terminal 110, in which the user credential 140 may be stored in a machine-readable code 134 on a user device 132 and the terminal 110 may have obtained the machine-readable code 134 from the user device 132. The processor may fetch, decode, and execute the instructions 404 to identify at least one authentication factor associated with the user 130 based on the user credential 140, in which the at least one authentication factor comprises a physical location associated with the user 130 and/or a time-based factor. That is, for instance, the processor may use the user credential 140 to identify the at least one authentication factor associated with the user 130.

The processor may fetch, decode, and execute the instructions 406 to compare the at least one authentication factor against authentication information. The authentication information may include, for instance, an approved location, tracked movements of the user 130, the user's work schedule, a statistical model of the user, and/or the like. Particularly, for instance, the authentication information may include information that identifies properties pertaining to instances in which the user 130 is to be granted access to the terminal.

The processor may fetch, decode, and execute the instructions 408 to determine whether the comparison indicates that the user 130 is to be granted access to the terminal 110, for instance, in any of the manners discussed herein. In addition, the processor may fetch, decode, and execute the instructions 410 to, based on a determination that the user 130 is to be granted access to the terminal 110, grant the user 130 access to the terminal 110. However, the processor may fetch, decode, and execute other instructions to, based on a determination that the user 130 is not to be granted access to the terminal 110, deny the user 130 access to the terminal 110. The processor may also fetch, decode, and execute instructions to determine an authentication policy to be applied to authenticate the user 130 and identify the at least one authentication factor from the determined authentication policy.

Although described specifically throughout the entirety of the instant disclosure, representative examples of the present disclosure have utility over a \wide range of applications, and the above discussion is not intended and should not be construed to be limiting, but is offered as an illustrative discussion of aspects of the disclosure.

What has been described and illustrated herein is an example of the disclosure along with some of its variations. The terms, descriptions and figures used herein are set forth by way of illustration only and are not meant as limitations. Many variations are possible within the scope of the disclosure, which is intended to be defined by the following claims—and their equivalents—in which all terms are meant in their broadest reasonable sense unless otherwise indicated.

What is claimed is:

1. An apparatus comprising:
a processor; and
a memory on which is stored machine-readable instructions that cause the processor to:
receive a user credential from a terminal, wherein the user credential is stored in a machine-readable code on a user device and the terminal obtained the machine-readable code from the user device;
identify at least one authentication factor associated with the user based on the user credential, wherein the at least one authentication factor comprises a physical location associated with the user and/or a time-based factor;
determine whether the at least one authentication factor indicates that the user is to be granted access to the terminal; and
based on a determination that the at least one authentication factor indicates that the user is to be granted access to the terminal, grant the user access to the terminal.

2. The apparatus of claim 1, wherein the instructions cause the processor to:
determine an authentication policy to be applied to authenticate the user; and
identify the at least one authentication factor from the determined authentication policy.

3. The apparatus of claim 2, wherein the instructions cause the processor to:
determine a security level associated with the terminal; and
determine the authentication policy to be applied to authenticate the user based on the security level associated with the terminal.

4. The apparatus of claim 1, wherein the instructions cause the processor to:
determine the physical location of the user when the terminal obtained the machine-readable code from the user device;
determine whether the physical location of the user is within an approved physical location of the user when the terminal obtained the machine-readable code from the user device to determine whether the at least one authentication factor indicates that the user is to be granted access to the terminal; and
determine that the user is to be granted access to the terminal based on a determination that the physical location of the user is within the approved physical location.

5. The apparatus of claim 1, wherein the instructions cause the processor to:
determine the physical location of the user when the terminal obtained the machine-readable code from the user device;
determine whether the user is currently or was recently logged into another terminal at a different geographic location to determine whether the at least one authentication factor indicates that the user is to be granted access to the terminal; and
determine that the user is not to be granted access to the terminal based on a determination that the user is currently or was recently logged into another terminal at the different geographic location.

6. The apparatus of claim 1, wherein the instructions cause the processor to:
determine a movement of the user prior to when the terminal obtained the machine-readable code from the user device;
determine whether the movement of the user complies with a predefined movement prior to when the terminal obtained the machine-readable code from the user device to determine whether the at least one authentication factor indicates that the user is to be granted access to the terminal; and
determine that the user is to be granted access to the terminal based on a determination that the movement of the user complies with the predefined movement.

7. The apparatus of claim 1, wherein the instructions cause the processor to:
determine whether the user is scheduled to be on-duty when the terminal obtained the machine-readable code from the user device to determine whether the at least one authentication factor indicates that the user is to be granted access to the terminal; and
determine that the user is to be granted access to the terminal based on a determination that the user is scheduled to be on-duty when the terminal obtained the machine-readable code from the user device.

8. The apparatus of claim 1, wherein the instructions cause the processor to:
access a statistical model of the user; and
determine whether the at least one authentication factor indicates that the user is to be granted access to the terminal based on the statistical model of the user.

9. The apparatus of claim 1, wherein the machine-readable code comprises a quick response code, a bar code, or a graphical code, and wherein the user device comprises a user-wearable device or a badge.

10. A method comprising:
receiving, by a processor, a user credential, wherein the user credential is stored in a machine-readable code on a user device and wherein a terminal obtained the machine-readable code from the user device to obtain the user credential;
determining, by the processor, an authentication policy to be applied to authenticate the user, the authentication policy identifying at least one authentication factor comprising a physical location associated with the user and/or a time-based factor;
determining, by the processor, whether the at least one authentication factor indicates that the user is to be granted access to the terminal; and
granting, by the processor, the user access to the terminal based on a determination that the at least one authentication factor indicates that the user is to be granted access to the terminal.

11. The method of claim 10, further comprising:
determining a security level associated with the terminal; and
determining the authentication policy to be applied to authenticate the user based on the security level associated with the terminal.

12. The method of claim 10, wherein the method further comprises:
determining the physical location of the user when the terminal obtained the machine-readable code from the user device;
determining whether the physical location of the user is within an approved physical location of the user when the terminal obtained the machine-readable code from the user device in determining whether the at least one authentication factor indicates that the user is to be granted access to the terminal; and
determining that the user is to be granted access to the terminal based on a determination that the physical location of the user is within the approved physical location.

13. The method of claim 10, wherein the method further comprises:
determining a movement of the user prior to when the terminal obtained the machine-readable code from the user device;
determining whether the movement of the user complies with a predefined movement prior to when the terminal obtained the machine-readable code from the user device or whether the movement is feasible to determine whether the at least one authentication factor indicates that the user is to be granted access to the terminal; and
determining that the user is to be granted access to the terminal based on a determination that the movement of the user complies with the predefined movement.

14. The method of claim 10, wherein the method further comprises:
determining the physical location of the user when the terminal obtained the machine-readable code from the user device;
determining whether the user is currently or was recently logged into another terminal at a different geographic location to determine whether the at least one authentication factor indicates that the user is to be granted access to the terminal; and
determining that the user is not to be granted access to the terminal based on a determination that the user is currently or was recently logged into another terminal at the different geographic location.

15. The method of claim 10, further comprising:
determining whether the user is scheduled to be on-duty when the terminal obtained the machine-readable code from the user device to determine whether the at least one authentication factor indicates that the user is to be granted access to the terminal; and
determining that the user is to be granted access to the terminal based on a determination that the user is scheduled to be on-duty when the terminal obtained the machine-readable code from the user device.

16. The method of claim 10, further comprising:
accessing a statistical model of the user;
applying the at least one authentication factor against the statistical model of the user; and
determining whether the at least one authentication factor indicates that the user is to be granted access to the terminal based on the application of the at least one authentication factor against the statistical model of the user.

17. A computer-readable medium on which is stored computer-readable instructions that when executed by a processor, cause the processor to:
receive a user credential from a terminal, wherein the user credential is stored in a machine-readable code on a user device and the terminal obtained the machine-readable code from the user device;
identify at least one authentication factor associated with the user based on the user credential, wherein the at least one authentication factor comprises a physical location associated with the user and/or a time-based factor;
compare the at least one authentication factor against authentication information;
determine whether the comparison indicates that the user is to be granted access to the terminal; and
based on a determination that the user is to be granted access to the terminal, grant the user access to the terminal.

18. The computer-readable medium of claim 17, wherein the instructions further cause the processor to:
determine an authentication policy to be applied to authenticate the user; and
identify the at least one authentication factor from the determined authentication policy.

19. The computer-readable medium of claim 17, wherein the authentication information comprises a statistical model of the user.

20. The computer-readable medium of claim 17, wherein the authentication information comprises information that identifies properties pertaining to instances in which the user is to be granted access to the terminal.
